(19) United States
(12) Patent Application Publication
(10) Pub. No.: US 2021/0264257 A1
(43) Pub. Date: Aug. 26, 2021

(54) AI Accelerator Virtualization

(71) Applicant: DINOPLUSAI HOLDINGS LIMITED, Fremont, CA (US)

(72) Inventors: Yujie HU, Fremont, CA (US); Xiaosong WANG, Fremont, CA (US); Tong WU, Fremont, CA (US); Steven SERTILLANGE, San Leandro, CA (US)

(21) Appl. No.: 16/975,685

(22) PCT Filed: Feb. 28, 2019
(86) PCT No.: PCT/US2019/020074

§ 371 Date: Aug. 25, 2020

Related U.S. Application Data
(63) Continuation of application No. 15/956,988, filed on Apr. 19, 2018.
Application No. 15/956,988 is a continuation of application No. 16/116,029, filed on Aug. 29, 2018.
(60) Provisional application No. 62/639,451, filed on Mar. 6, 2018.
(60) Provisional application No. 62/640,804, filed on Mar. 9, 2018.
(60) Provisional application No. 62/654,761, filed on Apr. 9, 2018.

(51) Int. Cl. G06N 3/08; G06N 3/063; G06F 7/544

(52) U.S. Cl. CPC G06N 3/08; G06N 3/04; G06F 7/5443; G06N 3/063

(57) ABSTRACT

An AI (Artificial Intelligence) processor for Neural Network (NN) Processing shared by multiple users is disclosed. The AI processor comprises a Multiplier Unit (MXU), a Scalar Computing Unit (SCU), a unified buffer coupled to the MXU and SCU to store data and a control circuitry coupled to the CCU and the unified buffer. The MXU comprises a plurality of Processing Elements (PEs) responsible for computing matrix multiplications. The SCU coupled to output of the MXU is responsible for computing the activation function. The control circuitry is configured to perform the space division and time division NN processing for a plurality of users. At one time instance, at least one of the MXU and SCU is shared by two or more users; and at least one user is using a part of the MXU while the other user is using a part of the SCU.

### CROSS REFERENCES

This application claims the benefit of U.S. Non-Provisional application Ser. No. 15/956,988, filed Apr. 19, 2018, which claims priority to U.S. Provisional Application No. 62/639,451, filed Mar. 6, 2018. This application also claims the benefit of U.S. Non-Provisional application Ser. No. 16/116,029, filed Aug. 29, 2018, U.S. Provisional Application No. 62/640,804, filed Mar. 9, 2018 and U.S. Provisional Application No. 62/654,761, filed Apr. 9, 2018. The U.S. Non-Provisional application and U.S. Provisional applications are incorporated by reference herein.

### FIELD OF THE INVENTION

The present invention relates to a computing device to accelerate artificial neural networks and other machine learning algorithms as required in neural networks

### BACKGROUND

An artificial intelligence (AI) accelerator is a class of microprocessor or computer system designed to accelerate artificial neural networks and other machine learning algorithms. A typical neural network has many layers with many nodes on each layer. The nodes are connected by arcs and each node has an activation function. For inference, each node must (i) multiply input data from each arc by appropriate weights; (ii) add the results from the multiplications; and (iii) apply an activation function. Training a neural network comprises determining the weights for all of the arcs and determining the activation functions for the nodes. Large neural networks can have thousands of nodes and millions of arcs, thereby requiring an enormous amount of calculations for training of and inference by the network. Recently, AI processors have been introduced for such large scale computations. Typically an AI accelerator has many processing cores and uses low-precision arithmetic. For example, some AI accelerators are implemented using ASICs (application specific integrated circuits) that comprise over 65,000, 8-bit integer multipliers.

The activation functions mentioned above are intended for illustration instead of an exhaustive list of all activation functions. In practice, other activation functions, such as Softmax function, are also being used.

### SUMMARY OF INVENTION

An AI (Artificial Intelligence) processor for Neural Network (NN) Processing is disclosed. The AI processor comprises a Core Computing Unit (CCU) comprising at least two Core Computing Elements (CCEs), a unified buffer coupled to the first CCE and the second CCE to store data and a control circuitry coupled to the CCU and the unified buffer. A first Core Computing Element (CCE), corresponding to one level of the CCU, comprises a plurality of Processing Elements (PEs), where each PE comprises a multiplier array, an adder tree and an accumulator. A second CCE, corresponding to another level of the CCU, coupled to output of the first CCE, where the second CCE comprises a plurality of Scalar Elements (SE), and each SE is configured to generate an output of one target activation function for an input to said each SE. The AI processor is configured to perform the NN processing for a plurality of users. At one time instance, at least one of said at least two CCEs is divided into at least two groups to allow at least two users of the plurality of users to share concurrently; and at least one part of one of said at least two CCEs is allocated to a first user of the plurality of users and at least one part of another of said at least two CCEs is allocated to a second user of the plurality of users, and wherein at another time instance after said one time instance, said at least one part of one of said at least two CCEs is allocated to one next user other than the first user of the plurality of users or said at least one part of another of said at least two CCEs is allocated to one next user other than the second user of the plurality of users. Accordingly, the AI processor according to the present invention discloses a flexible AI processor virtualization to allow multiple users to share the resource in space division as well as in time division.

The unified buffer can store activation data for a current layer, one or more next layers, one or more previous layers, or a combination thereof. Furthermore, the unified buffer can store output of one SE for the current layer, and the output of one SE for the current layer can be provided to one PE as the activation data for one next layer. In one embodiment, the unified buffer is implemented based on dual-port memory including a read port and a write port. Furthermore, the read port can be coupled to a read arbiter to arbitrate read request from the first CCE, the second CCE and one data multiplexer, and the write port can be coupled to a write arbiter to arbitrate write request from the first CCE, and one data multiplexer.

In one embodiment, the control circuitry comprises a command sequencer to send commands to the first CCE, the second CCE and the unified buffer to move data around or to control computations for the NN processing. The control circuitry may be coupled to a host CPU (central processing unit) to receive commands for the NN processing.

The AI processor may further comprise one or more data multiplexes coupled to the CCU, the control circuitry and the unified buffer to switch data.

In one embodiment, the first CCE comprises a weight buffer to store weights for the NN processing. The control circuitry can be further configured to fetch activation data from the unified buffer and weight data from the weight buffer to compute vector multiplication of the activation data and the weight data.

In one embodiment, each PE comprises an array of FP16 (floating point 16-bit) multipliers and each FP16 multiplier is configured as one FP16 multiplier or two int8 (integer 8-bit) multipliers.

The target activation function can be selected out of an activation function pool. Each SE may comprise a linear function core, a nonlinear function core, pooling function core, a cross channel function core, a programmable function core, a training core, or a combination thereof.

The AI processor may further comprise an interconnection interface to access on-chip configuration registers and memories through an external bus. The interconnection interface may correspond to PCIe (Peripheral Component Interconnect Express)/DMA (Direct Memory Access) block. The PCIe/DMA block may be used to transfer data between a host memory and both on-chip and off-chip memories by using AXI stream interfaces.

In one embodiment, said at least one of said at least two CCEs is divided into two unequal groups for two users of the plurality of users to share concurrently.

### BRIEF DESCRIPTION OF THE DRAWINGS

FIG. 1A-FIG. 1C illustrate major parts associated with a block diagram of an AI accelerator according to various embodiments of the present invention.

FIG. 2 illustrates a block diagram of the command sequencer according to various embodiments.

FIG. 3 illustrates a block diagram of the UB (Unified Buffer) according to various embodiments of the present invention.

FIG. 4 illustrates an example of “space division” based AI accelerator virtualization according to an embodiment of the present invention.

FIG. 5 illustrates an exemplary flowchart of “time division” based AI accelerator virtualization according to an embodiment of the present invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention.

Reference throughout this specification to “one embodiment,” “an embodiment,” or similar language means that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention.

The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

In the description like reference numbers appearing in the drawings and description designate corresponding or like elements among the different views.

Various embodiments of the present invention are directed to virtualization of an AI accelerator. Before describing the virtualization aspects of the present invention, a brief description of an exemplary AI accelerator is provided.

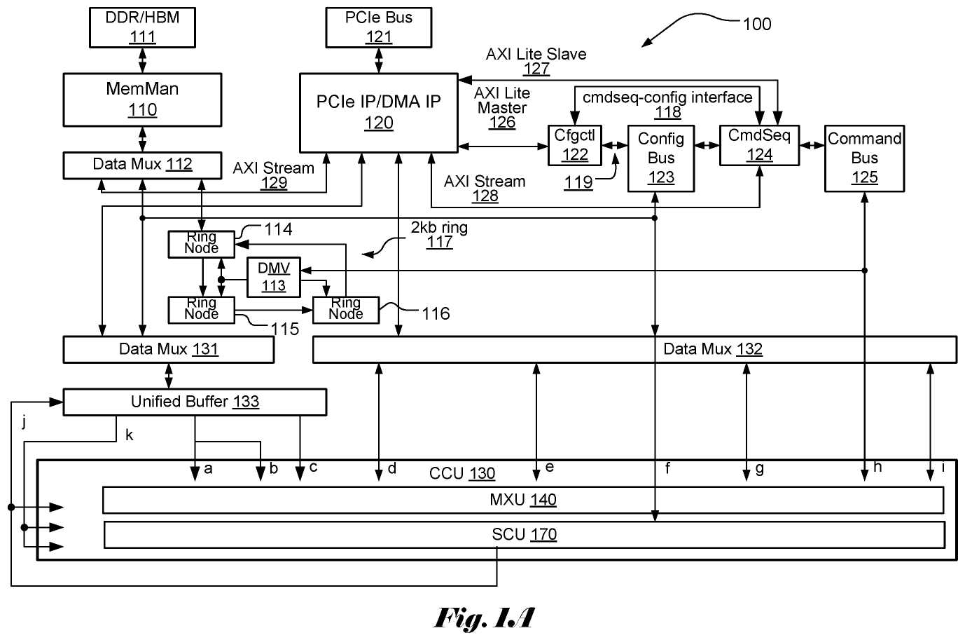

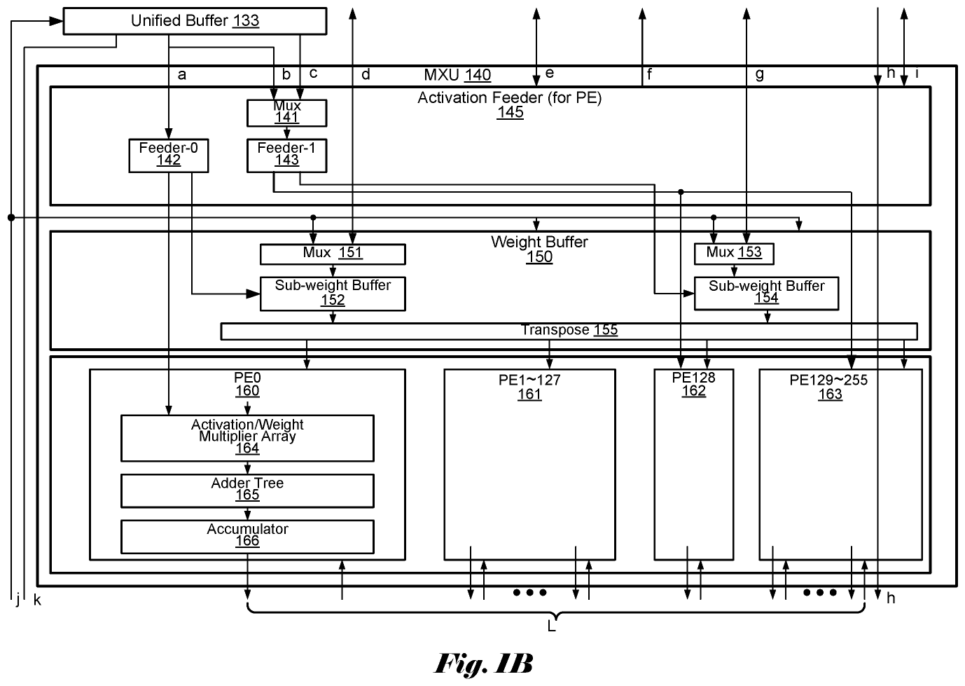

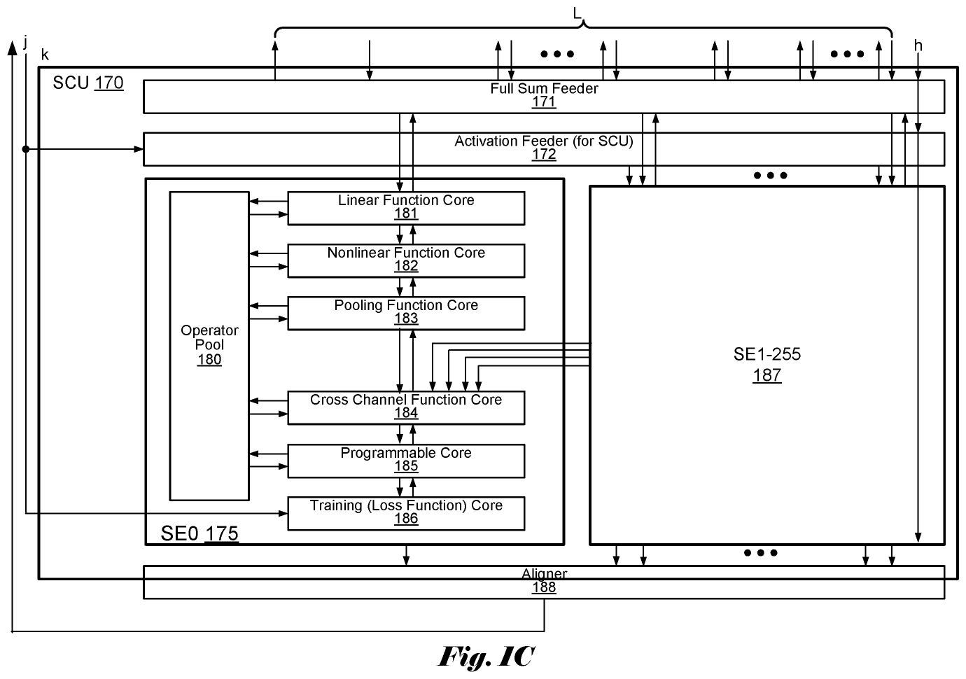

FIG. 1A-FIG. 1C illustrates parts of a block diagram of an AI accelerator according to various embodiments of the present invention. The AI accelerator depicted in FIG. 1A-FIG. 1C is exemplary and the virtualization aspects of the present invention can be realized with other types of AI accelerator configurations.

The AI accelerator depicted in FIG. 1A-FIG. 1C include a Core Compute Unit (CCU) 130 (in FIG. 1A), which comprises a Matrix Multiplier Unit (MXU 140 in FIG. 1B) and a Scalar Computation Unit (SCU 170 in FIG. 1C). In other embodiments, multiple CCUs may be used. In FIG. 1B, the MXU 140 consists of an activation feeder 145, a Weight Buffer (WB) 150 with a number of memories, with one memory for each of the Processing Elements (PEs, 160-163) in the MXU (e.g., 256 processing elements (PEs)). Each PE may comprise an Activation/Weight multiplier array 164, an adder tree 165, and an accumulator 166. The activation feeder 145 may comprise two feeders (Feeder-0 142 and Feeder-1 143) for fetching activation data, where Feeder-0 142 receipts information from Unified Buffer (UB) 133 and provides the information to Activation/Weight multiplier array 164 and sub-weight buffer 152 in WB 150. The buffer can store activation, weights or other items like command sequencer instructions and that is the reason it is called Unified Buffer (UB), Feeder-1 receives input from Multiplexer (Mux 141). Mux 141 receives two inputs from Unified Buffer 133. Feeder-1 143 provides outputs to Sub-weight Buffer 154 in WB 150 and PE128 through PE255 (162 and 163). The WB 150 comprises two sets of Mux (151 and 153) and sub-weight buffers (152 and 154). The outputs from sub-weight buffers (152 and 154) are provided to transpose 155.

As is known for NN processing, in each layer of the NN processing, the activation data are multiplied by respective weights. The weighted sum is then provided to the input of an activation function. The output signal from the activation function becomes the activation data for the next layer of the NN processing. The MXU is primarily responsible to calculate the weighted sum for the activation data. On the other hand, the SCU is primarily responsible for computing the output for a selected activation function. The CCU comprises two main elements, i.e., the MXU 140 and the SCU 170. For convenience, both MXU and SCU are referred as Core Computing Elements (CCEs). In other words, the MXU may be referred as a first CCE and the SCU may be referred as a second CCE.

The SCU 170 as shown in FIG. 1C may comprise a full sum feeder 171, an activation feeder 172 (for the purpose of training and is different from the feeder for the PEs), a number of scalar elements (SE, 175 and 187) (e.g., 256 scalar elements, one for each PE), an aligner 188 to align the outputs of all the SEs and a padding block (not shown in the FIG. 1C) to pad programmable data to the aligner's results before writing them into a Unified Buffer (UB) 133. Each SE may comprise a linear function core 181, a non-linear function core 182, a pooling function core 183, a cross-channel function core 184, a programmable core 185, a training (loss function) core 186, and an operator pool 180. The operator pool 180 comprises a set of operations that is used to implement various activation functions.

A configuration control (cfgctl) 122 can be connected to an interconnection core, such as the PCIe (Peripheral Component Interconnect Express)/DMA (Direct Memory Access) block 120 shown in FIG. 1A, via an interface, such as an AXI-Lite master interface 126. The cfgctl block 122 is responsible for bridging the interface from the PCIe IP/DMA block 120 to an internal config bus 123 that is used to access on chip configuration registers and memories in various blocks.

A command sequencer (cmdseq) 124 preferably receives commands from a host CPU (not shown) and sends commands to various blocks to either move data around or to start computation for a neural network. The cmdseq 124 can also control the config bus 123 to access on chip configuration registers and memories in various blocks. Furthermore, the cmdseq 124 can also control the Command Bus 125. Cmdseq 124 may also comprise an arithmetic unit to compute various addresses, offsets or controls to assist virtualization of address space and multi-user data allocation. The cfgctl 122 may also comprise arbitration logic to coordinate the access requests from both the PCIe/DMA 120 and the cmdseq 124. The cmdseq 124 can also program the PCIe/DMA block 120 via an AXI-Lite slave interface 127. The PCIe/DMA block 120 may also be used to transfer data between the host memory and both on-chip and off-chip memories by using AXI stream interfaces 129. The AI accelerator may comprise, for example, 16 MB or so of on-chip memory and several GB of off-chip memory. A data mover (DMV) block 113 is used to control data transfer between on-chip memories and off-chip memories via a 2 kb wide ring bus 117, which comprises three Ring Nodes (115, 115 and 116) as an example.

The configuration control block preferably comprises three interfaces: AXI-Lite master interface, cmdseq-config interface 118, and internal config bus interface 119. The AXI-Lite interface 127 is for the host CPU to configure the chip while the cmdseq interface 118 is for the cmdseq 124 to configure the chip. The internal config bus 119 may consist of the following signals: 48 b address/data bus; read/write signal; Request valid signal; Write acknowledge signal; Read data valid signal; and 32 b read data bus.

A data mux block 112 can switch data from (1) the PCIe/DMA block 120, (2) config bus 123, and (3) DMV 113 to both on-chip and off-chip memories. Three data mux blocks (112, 131 and 132) may be used: one (i.e., data mux 112) for off-chip memory (i.e., DDR or HBM 111) via a memory controller block or memory management block (MemMan 110), one (i.e., data mux 131) for AB 133, and another one (i.e., data mux 132) for WB 150 (in FIG. 1B). The PCIe/DMA block 120 usually has multiple channels, so each data mux can use one channel. The cmdseq 124 may also use one channel for moving data from its command buffer memory to the host memory. FIG. 1 consists of FIG. 1A, FIG. 1B and FIG. 1C

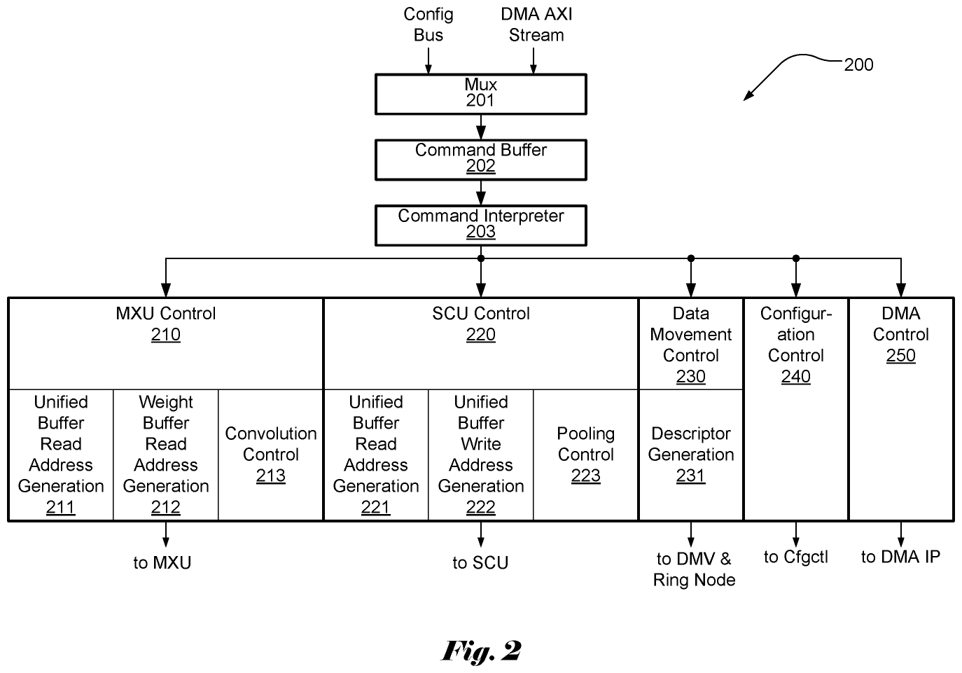

The main purpose of the command sequencer 124 (in FIG. 1A) is to consolidate all the controls in one place. FIG. 2 is a block diagram of the command sequencer 200 according to various embodiments. The MXU 140 (in FIG. 1B) is only responsible for performing matrix (actually a portion of it, called “tile”) multiplication with its PEs (i.e., blocks 160-163 in FIG. 1B) responsible for vector multiplication. The MXU takes addresses from the cmdseq 124 (in FIG. 1A) to fetch activation data from the AB 133 (in FIG. 1A) as well as to fetch the weights from the weight buffer 150 (in FIG. 1B). To support convolution, the MXU 140 needs additional information to form activation vectors for its PEs. Accordingly, within the MXU control block 210, a unified buffer read address generation block 211 is used for fetching activation data from the AB 133; a weight buffer read address generation block 212 is used for fetching the weights from the weight buffer 150; and a convolution control block 213 is used for forming activation vectors for its PEs.

The SCU 170 (in FIG. 1C) is also preferably not directly controlled by the host but it does have host configurable registers. The cmdseq can control the config bus, so it can also configure the SCU 170 for the host if instructed with a specific command. Accordingly, within the SCU control block 220, a unified buffer read address generation block 221 is used for fetching activation data from the AB 133; a unified buffer write address generation block 222 is used for writing activation data to the AB 133; and a pooling control block 223 is used for selecting corresponding operators from the operator pool 180 in order to implement a target activation function.

The cmdseq also controls data movement between on chip and off chip memories. It preferably can program the PCIe/DMA controller to control data movement between on chip/off chip memories and the host memory. In various embodiments, essentially all address generation or determination will be done by the cmdseq with the rest of the chip using the generated addresses or their increments to fetch data for computing or data transfer. Accordingly, within the data movement control block 230, a descriptor generation block 231 is used to generate addresses or their increments for fetching data for computing or data transfer.

The memory management block may have interface to the data mux and off-chip memory controller blocks. The memory management block may have no configurable features although the off-chip memory controller block usually has some. The memory management block is mainly used as a bridge between the data mux interfaces and the memory controller interface. Accordingly, the command sequencer 200 in FIG. 2 also includes a configuration control block 240 to control the cfgctl 122 and a DMA control block 250 to control DMA block 120.

Preferably, the memory management is not responsible for performance tuning because the memory controller block usually comes with performance tuning features. The host CPU preferably configures the memory controller block properly to maximize off-chip memory access efficiency. Since the weight buffer and the unified buffer are preferably sized to support most known neural networks, off-chip memory performance tuning may not be critical.

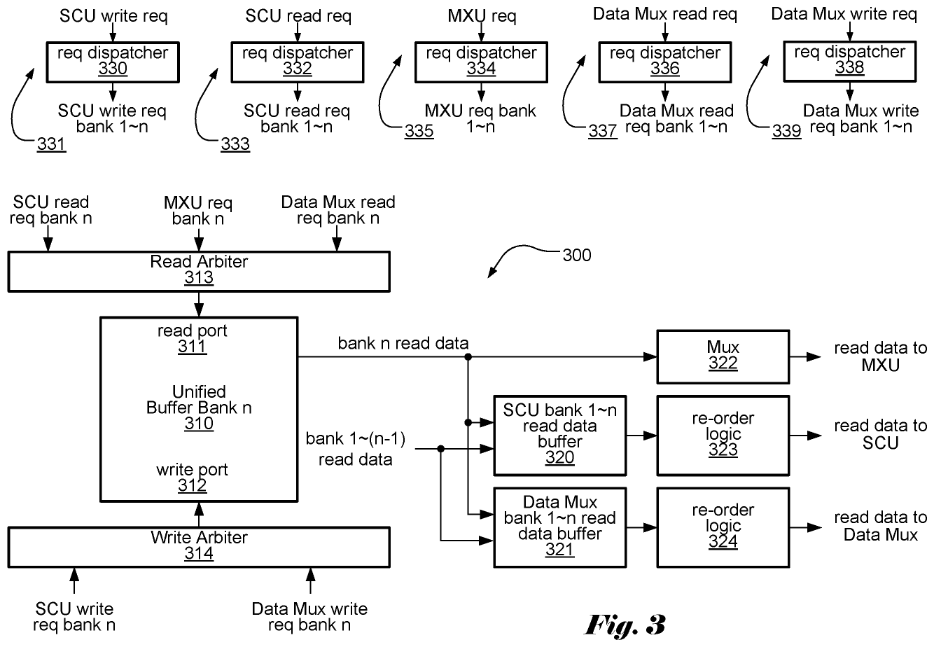

FIG. 3 is a block diagram of the UB (Unified Buffer) 300 according to various embodiments of the present invention. The AB 300 can be used to store feature data, activation data (for current layer, next layer, and several or all previous layers), training target data, weight gradients, and arc weights (e.g., 32-bit floating point arc weights). FIG. 3 illustrates an exemplary unified buffer having n buffer banks. The activation banks can be accessed by SCU, MXU and data Mux. Each buffer bank (e.g. unified buffer bank n 310) has a read port 311 and a write port 312. The read port 311 is connected to a read arbiter 313 to arbitrate the read requests from SCU, MXU and data Mux. The write port 312 is connected to a write arbiter 314 to arbitrate the write requests from SCU and data Mux. The requested read data can be provided to Mux through Mux 322. The requested read data can be provided to a SCU read buffer 320 and a data Mux buffer 321, which store SCU read data and data Mux read data from n buffer banks. The read data stored in SCU read data buffer 320 and data Mux read data buffer 321 may be reordered by re-order logics 323 and 324 before the read data are provided to SCU and data Mux respectively. A request (req) dispatcher may be used to convert a read or write request into corresponding read or write requests for n buffer banks. For example, in scenario 331, the SCU write request is converted by req dispatcher 330 into SCU write request for buffer banks 1˜n. In scenario 333, the SCU read request is converted by req dispatcher 332 into SCU read request for buffer banks 1˜n. In scenario 335, the MXU request is converted by req dispatcher 334 into MXU request for buffer banks 1˜n. In scenario 337, the data Mux read request is converted by req dispatcher 336 into data Mux read request for buffer banks 1˜n. In scenario 339, the data Mux write request is converted by req dispatcher 338 into data Mux write request for buffer banks 1˜n.

The total size of the unified buffer can be 64 MB, for example. Each type of data can be stored in the allocated partition. If the allocated partition is not big enough to hold all the required data for operations, the AB can work as an on-chip cache, with all data stored in off-chip memory.

For data that will be accessed in a sequential manner, the cache can be implemented as a FIFO. Each cache FIFO may consist of multiple cache lines with configure line sizes (or FIFO depth). A FIFO may be pushed with a configurable number of lines whenever its occupancy has fallen below a configurable threshold. To maximize off-chip memory bandwidth, the configurable number of lines should be big enough.

The weight buffer can be implemented, for example, with 256 separate memories each for one of the 256 PEs. The weight buffer preferably is sized to be big enough to hold the weights of the entire neural network. When the weight buffer is not big enough, additional weights can be loaded from off-chip memory or from the Unified Buffer by using DMV configured by the cmdseq.

The activation feeder 145 can be responsible for initiating the loading of weights from off-chip memory because it is responsible for traversing the weight matrix. This particular function may also be moved to the cmdseq 124.

The core of each processing element (PE) comprises, for example, 256 int8 multipliers (e.g. activation/weight multiplier array 164 in FIG. 1B), an adder tree (e.g. adder tree165 in FIG. 1B) and an accumulator (e.g. accumulator 166 in FIG. 1B). Since the MXU (e.g. MXU 140 in FIG. 1B), in various embodiments, may comprise 256 PEs, there can be approximately 65,000 multipliers in the MXU (e.g., 256×256=65,536). The multipliers of the MXU perform computations at a high rate. For example, the cycle rate may be on the order of hundreds of MHz, so that that the MXU executes one the order of 10¹² operations per second (or many teraops). In other embodiments, the MXU could include more than 256 PEs, such as 512 PEs or some other quantity, which would increase the operation rate for the MXU (assuming the cycle rate was not inversely reduced).

There can be two multiplication modes: integer 8-bit (int8) and floating point 16-bit (FP16). In the FP16 mode, two int8 multipliers plus some additional logic can be ganged together for FP16 multiplication.

Each PE can use a number (e.g., 41) of accumulator buffers (e.g. accumulator 166 in FIG. 1B). Each accumulator buffer may comprise an adder and a buffer memory. Each entry of the buffer memory stores the partial sum of a weight row multiplied by an activation column. The activation feeder 145 (actually the cmdseq 124) knows which partial sum belongs to which row of which tile and can send information to the PE (160 to 163) to route the partial sum to the allocated entry in the accumulator buffer. The information often includes a full sum ID, which is the same as the partial sum ID. Since at any given time, one partial sum may be available, traversing of the weight matrix may be done in a one-tile-row manner. A tile row may span the entire row of the weight matrix. Traversing in a one-tile-row manner will maximize activation reuse.

The accumulator buffer memory preferably is implemented with simple dual port memory with one port for read and another port for write. When the full sum is available (i.e., last partial sum of a weight row is available), the activation feeder can send an indication to the SCU so that the SCU can pull it. When a full sum is pulled out of an accumulator memory, the PE preferably stalls because its read port is now being used to read full sum out.

AI accelerators, such as the example described above, may be employed in one or more servers comprising a data center. A server at a data center may comprise one or more CPUs and one or more such AI accelerators. The CPU(s) is/are in communication with the AI accelerator(s) via a high-speed data bus, such as a PCIe bus 121 in FIG. 1A. The AI accelerator may also include on-chip (or on-board) memory (e.g., RAM or ROM), and the AI accelerator could also be in communication with off-chip memory, i.e., RAM or ROM that is connected to the AI accelerator via a high-speed data bus. The AI accelerator may comprise, for example, 16 MB or so of on-chip memory and several GB of off-chip memory.

Now that general aspects of an AI accelerator have been described, attention is now turned to the virtualization aspects. A data center where such AI accelerators are employed may process AI-related tasks and computations for numerous concurrent users. As generally described below, in one embodiment, different users can share different components of an AI accelerator at the same time (e.g., “space division”); in another embodiment different users can use the same components of the AI accelerator but at different times (e.g., “time division”); and in yet another embodiment different uses can share different components at different time (e.g., “space and time division”).

In one embodiment of the virtualization, each concurrent user is allocated a separate, virtualized hardware memory space. For example, each concurrent user may be allocated separate hardware memory space in all on-chip and off-chip memories of the AI accelerator. That way, data from the concurrent users are not commingled, i.e., are isolated from each other.

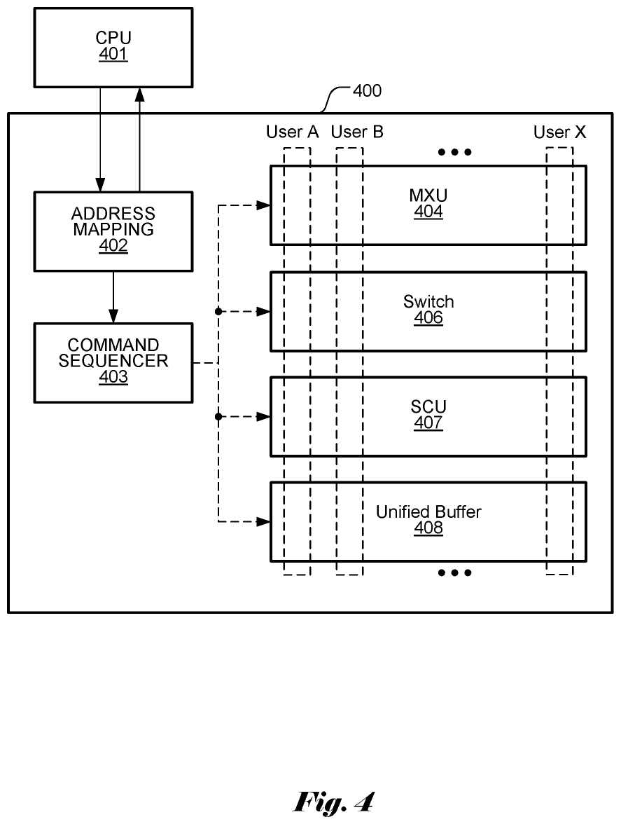

As shown in FIG. 4, the AI accelerator 400 may comprise an address mapping block 402 that communicates with the host CPU 401 (e.g., CPU of the server where the AI accelerator is employed). The address mapping block 402 can receive from the CPU the requests from the concurrent users for access to the AI accelerator. Based on the ID of the user in the request, the address mapping block can map each of the concurrent users to their dedicated memory spaces and dedicated components in the MXU 404, SCU 407 and unified buffer 408 (also referred to as activation buffer). The command sequencer can send signals to each of the MXU 404, SCU 407 and unified buffer 408 to instruct the components as to which components are for each of the concurrent users.

For example, as shown in FIG. 4, User A would be allocated dedicated PEs in the MXU as well as dedicated buffers in the accumulator of the dedicated PEs, dedicated scalar elements (SEs) in the SCU and dedicated buffers in the unified buffer. User B in turn is allocated different dedicated components in these components, and so on for all of the dedicated users. That way, the components dedicated to User A can perform their operations in parallel with the components dedicated to User B, and so on. Components of the switch 406 may not be dedicated to each concurrent user, but the switch 406 connects, for example, the buffers in accumulator to the SCs in the SCU 407 for each concurrent user. In various embodiments, each concurrent user may be allocated two PEs in the MXU, such that the number of concurrent users would be as high as half the number of PEs, such as 128 concurrent users for a MXU with 256 PEs. In the example shown in FIG. 4, there may be other users (e.g. User X) to share the AI accelerator.

In the time division virtualization, the components of the AI accelerator perform operations for one user (e.g., User A) for a number of clock cycles and then the components perform operations for another user for another number of clock cycles, and so on for each of the concurrent user. At the end of the operations for one user, all of the data for that user may be stored in the dedicated memory for that user (on-chip or off-chip memory). The data that are stored for each user may comprise the MXU, SCU and UB states for each user. When it is that user's turn again, the data is read out of the dedicated memory for that user and into the various components (e.g., the MXU, SCU and UB) to continue the operations for that user. In that connection, in various embodiments, the address mapping block may comprise a context pointer for each user, which context pointer points to where the MXU, SCU and UB state data for each respective user are stored. The storing and loading of the data to and from the AI accelerator memory (whether on-chip or off-chip) can be performed at a high rate since it is performed with the hardware shown in FIG. 1A-FIG. 1C, for example. Data stored for each user at any location may be encrypted and/or obfuscated and/or flushed automatically by the cmdseq or by the host controller, to ensure total privacy.

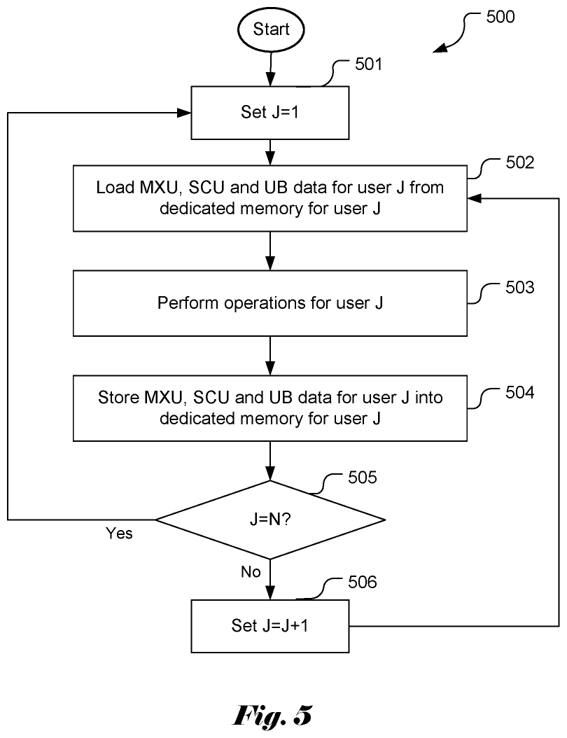

FIG. 5 is a flowchart of a general process 500 performed by the AI accelerator, under control of the command sequencer, to implement this process according to various embodiments of this invention. FIG. 5 assumes that there are N total concurrent users. First, at step 501, a counter for the user, here “J” is set to 1. Then, in turn, for each User J, the MXU, SCU and UB data for User J are loaded from the dedicated memory space for User J into the MXU, SCU and UB (step 502); the MXU, SCU and UB perform the operations for User J for a set number of operation cycles (step 503); and then the MXU, SCU and UB data for User J are stored in the dedicated memory space for User J (step 504) so that the process can be repeated for the next user until the process has been performed for all of the N users. A test is performed to check whether the user is the last user (i.e., “Is J=N”) in step 505. If the user is the last user (i.e., the “Yes” path from step 505), the user counter J is rest to “1”. If the user is not the last user (i.e., the “No” path from step 505), the user counter J is incremented to the next user (i.e., “J=J+1”).

The time division between the concurrent users does not need to be equal. For example, the time period for some users could be longer (more clock cycles) than others. Also, the time periods for some user could be more frequent than others. For example, if there 5 users (e.g. Users A, B, C, D and E), the cycle could be A→B→C→D→E→A→B→C→D→E as suggested in FIG. 5, or some other sequence could be used that benefits some users over others, such as ones that pay for higher service levels, such as a sequence such as A→B→C→A→D→E→A→B→C→A→D→E and so on, in which case User A's turn is more frequent that the other users.

The space and time division virtualization can be a combination of the space division virtualization and the time division virtualization. That is, a first group of users may take turns using a first dedicated set of components in the MXU, SCU and UB, a second group users may take turn using a second dedicated set of components in the MXU, SCU and UB, and so on. The users in one group would take turns by time (i.e., time division), with each user's data being stored in their dedicated memory at the end of their turn, and then re-loaded into the MXU, SCU and UB when their next turn begins.

The AI accelerator hardware along with configurable feature allows time division virtualization, time division virtualization as well as a combination of time division virtualization and time division virtualization (referred as hybrid time-space division virtualization). The hardware architecture as shown in FIG. 1A-FIG. 1C can be mapped to one layer of multi-layer neural network (NN) processing. As is known in the field, the NN processing involves multiplying an activation vector by a corresponding weight vector, computing the partial sum of the weighted activation signals, accumulating the partial sum, applying activation function to the full sum to generate an output. The multiplication of the activation vector and the corresponding weight vector can be performed by the activation/weight multiplier array in a PE. The adder tree in the PE is then used to compute the partial sum. Accumulating the partial sum can be performed by the accumulator in the PE. The activation function can be implemented using the SE in the SCU. A proper function core can be selected by the operator pool in the SE to implement a selected activation function. The Core Compute Unit (CCU) can support one layer of NN processing. The multi-layer NN processing can be implemented by looping the activation output back to the input of the MXU.

FIG. 4 illustrates an example of space division virtualization, where dedicated MXU, Switch, SCU and unified buffer are assigned to each users. However, in a combination of time division virtualization and time division virtualization, there is no need to dedicate a set of full-level computing unit to each user. For example, at one time instance, the MXU can be shared by two users (e.g. User A and User B) and each uses 128 PEs to compute the full sum if the MXU comprises 256 PEs. At the same instance, all SEs can be allocated to User C to perform the required activation function. The outputs from the MXU and the outputs from can be stored in the unified buffer. In the next time instance, the SCU can be shared by User A and User B. At the same time, the MXU is all allocated to User C. Furthermore, the hardware resources do not have to be equally divided among users. For example, 64 PE can be allocated to User A and 128 PEs can be allocated to User B.

As mentioned before, the command sequencer joined by the configuration control plays an important role to coordinate the overall operations of the computing core. The command sequencer sends commands to various blocks to either move data around or to start computation for a neural network. The command sequencer and the configuration control are all referred as control circuitry in this disclosure. The hybrid time-space division virtualization as disclosed herein allows dynamic job allocation for multiple users.

In various embodiments disclosed herein, a single component may be replaced by multiple components and multiple components may be replaced by a single component to perform a given function or functions. Except where such substitution would not be operative, such substitution is within the intended scope of the embodiments.

While various embodiments have been described herein, it should be apparent that various modifications, alterations, and adaptations to those embodiments may occur to persons skilled in the art with attainment of at least some of the advantages. The disclosed embodiments are therefore intended to include all such modifications, alterations, and adaptations without departing from the scope of the embodiments as set forth herein.

The above description is presented to enable a person of ordinary skill in the art to practice the present invention as provided in the context of a particular application and its requirement. The invention may be embodied in other specific forms without departing from its spirit or essential characteristics. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Various implementations of the systems and techniques described here can be realized in digital electronic circuitry, integrated circuitry, specially designed ASICs (application specific integrated circuits), field programmable gate array (FPGA), and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor. The software code or firmware codes may be developed in different programming languages and different format or style. The software code may also be compiled for different target platform. However, different code formats, styles and languages of software codes and other means of configuring code to perform the tasks in accordance with the invention will not depart from the spirit and scope of the invention.

What is claimed is:

1. An AI (Artificial Intelligence) processor for Neural Network (NN) Processing, comprising:
a Core Computing Unit (CCU) comprising at least two Core Computing Elements (CCEs), wherein
a first Core Computing Element (CCE), corresponding to one level of the CCU, comprises a plurality of Processing Elements (PEs), wherein each PE comprises a multiplier array, an adder tree and an accumulator;
a second CCE, corresponding to another level of the CCU, coupled to output of the first CCE, wherein the second CCE comprises a plurality of Scalar Elements (SE), and each SE is configured to generate an output of one target activation function for an input to said each SE;
a unified buffer coupled to the first CCE and the second CCE to store data;
a control circuitry coupled to the CCU and the unified buffer; and
wherein the AI processor is configured to perform the NN processing for a plurality of users;
wherein at one time instance:
at least one of said at least two CCEs is divided into at least two groups to allow at least two users of the plurality of users to share concurrently; and
at least one part of one of said at least two CCEs is allocated to a first user of the plurality of users and at least one part of another of said at least two CCEs is allocated to a second user of the plurality of users, and wherein at another time instance after said one time instance, said at least one part of one of said at least two CCEs is allocated to one next user other than the first user of the plurality of users or said at least one part of another of said at least two CCEs is allocated to one next user other than the second user of the plurality of users.

2. The AI processor of claim 1, wherein the unified buffer stores activation data for a current layer, one or more next layers, one or more previous layers, or a combination thereof.

3. The AI processor of claim 2, wherein the unified buffer stores output of one SE for the current layer, and wherein the output of one SE for the current layer is provided to one PE as the activation data for one next layer.

4. The AI processor of claim 1, wherein the unified buffer can be implemented based on dual-port memory including a read port and a write port. Is this necessary? Implementation can very well vary and is not limited to 2 port memories. I would probably remove that sentence.

5. The AI processor of claim 4, wherein the memories are coupled to a read arbiter to arbitrate read request from the first CCE, the second CCE and one data multiplexer, and also coupled to a write arbiter to arbitrate write request from the first CCE, and one data multiplexer.

6. The AI processor of claim 1, wherein the control circuitry comprises a command sequencer to send commands to the first CCE, the second CCE and the unified buffer to move data around or to control computations for the NN processing.

7. The AI processor of claim 1, wherein the control circuitry is coupled to a host CPU (central processing unit) to receive commands for the NN processing.

8. The AI processor of claim 1, further comprising one or more data multiplexes coupled to the CCU, the control circuitry and the unified buffer to switch data.

9. The AI processor of claim 1, wherein the first CCE comprises a weight buffer to store weights for the NN processing.

10. The AI processor of claim 9, wherein the control circuitry is further configured to fetch activation data from the unified buffer and weight data from the weight buffer to compute vector multiplication of the activation data and the weight data.

11. The AI processor of claim 1, wherein each PE comprises an array of FP16 (floating point 16-bit) multipliers and each FP16 multiplier is configured as one FP16 multiplier or two int8 (integer 8-bit) multipliers.

12. The AI processor of claim 1, wherein said one target activation function is selected out of an activation function pool.

13. The AI processor of claim 12, wherein each SE comprises a linear function core, a nonlinear function core, pooling function core, a cross channel function core, a programmable function core, a training core, or a combination thereof.

14. The AI processor of claim 1, further comprising an interconnection interface access on-chip configuration registers and memories through an external bus.

15. The AI processor of claim 14, wherein the interconnection interface corresponds to PCIe (Peripheral Component Interconnect Express)/DMA (Direct Memory Access) block.

16. The AI processor of claim 15, wherein the PCIe/DMA block is used to transfer data between a host memory and both on-chip and off-chip memories by using AXI stream interfaces.

17. The AI processor of claim 1, wherein said at least one of said at least two CCEs is divided into two unequal groups for two users of the plurality of users to share concurrently.

18. An AI (Artificial Intelligence) system for Neural Network (NN) Processing, comprising:
a system processor;
a system memory device;
an interconnection interface; and
an AI (Artificial Intelligence) processor coupled to the interconnection interface; and
wherein the AI processor comprises:
a Core Computing Unit (CCU) comprising at least two Core Computing Elements (CCEs), wherein
a first Core Computing Element (CCE), corresponding to one level of the CCU, comprises a plurality of Processing Elements (PEs), wherein each PE comprises a multiplier array, an adder tree and an accumulator;
a second CCE, corresponding to another level of the CCU, coupled to output of the first CCE, wherein the second CCE comprises a plurality of Scalar Elements (SE), and each SE is configured to generate an output of one target activation function for an input to said each SE;
a unified buffer coupled to the first CCE and the second CCE to store data;
a control circuitry coupled to the CCU and the unified buffer; and
wherein the AI processor is configured to perform the NN processing for a plurality of users;
wherein at one time instance:
at least one of said at least two CCEs is divided into at least two groups to allow at least two users of the plurality of users to share concurrently; and
at least one part of one of said at least two CCEs is allocated to a first user of the plurality of users and at least one part of another of said at least two CCEs is allocated to a second user of the plurality of users, and wherein at another time instance after said one time instance, said at least one part of one of said at least two CCEs is allocated to one next user other than the first user of the plurality of users or said at least one part of another of said at least two CCEs is allocated to one next user other than the second user of the plurality of users.
